(19) United States
(12) Patent Application Publication
(10) Pub. No.: US 2008/0063244 A1
(43) Pub. Date: Mar. 13, 2008

(54) Biometric apparatus and biometric method

(76) Inventors: Yuichiro Tanaka, Hadano (JP); Tetsuya Mochida, Machida (JP); Harumi Sato, Sagamihara (JP)

Correspondence Address: MCDERMOTT WILL & EMERY LLP, 600 13TH STREET, N.W., WASHINGTON, DC, 20005-3096, US

(21) Appl. No.: 11/898,643

(22) Filed: Sep. 13, 2007

(30) Foreign Application Priority Data
Sep. 13, 2006 (JP) 2006-247871

(51) Int. Cl. G06K 9/00

(52) U.S. Cl. 382/115

(57) ABSTRACT

A biometric apparatus is provided that comprises a personal computer (PC), and a finger vein authentication module connected to the PC, wherein the PC retrieves finger vein position information of an organism from a biometric image obtained during registration of a user for displaying on the screen of a liquid crystal display during authentication, and superimposes current finger contour information obtained during the authentication on the finger contour position information for displaying on the screen of the liquid crystal display. With this, even when the biometric apparatus is not provided with a jig that fixes the organism, it is possible, during the authentication, to cause the organism to match the position and angle a template captured during registration, and to complete the authentication rapidly.

### INCORPORATION BY REFERENCE

The present application claims priority from Japanese application JP2006-247871 filed on Sep. 13, 2006, the content of which is hereby incorporated by reference into this application

### BACKGROUND OF THE INVENTION

The present invention relates to a biometric apparatus for authenticating individuals through the use of biometric information, and, more particular, to a technology that is preferably used for a contact-free biometric technology.

What has been attracting special attention in recent years among biometric technologies represented by fingerprint authentication is a vein authentication that uses finger or palm vein pattern. The vein authentication, in which near infrared rays are irradiated and vein patterns in the finger or palm is read, has an advantage that authentication data is hard to be counterfeited compared with a contact type fingerprint authentication.

On the other hand, the vein authentication has a disadvantage that the size of the apparatus is prone to increase. However, a compact vein authentication module has recently made its appearance, and a personal computer that contains such a module and an external USB-connected finger vein module have been commercially produced.

A technology of finger placement guide for aligning a finger when performing the vein authentication is also described, for example, in JP-A-2005-128936 and the like.

### SUMMARY OF THE INVENTION

Since, in the compact finger vein authentication module as described in the foregoing, a camera used for image pickup is small-sized, the vein pattern range that can be obtained is relatively small. As a result, the data obtained during biological data registration does not easily match the data obtained during authentication, requiring the adjustment of the relative position and angle by moving an organism. Therefore, it sometimes takes time before the authentication completes.

Even if a relatively large-sized CCD camera is used, there is also a problem that there exists a structural restriction or there is a health or sanitary problem in an environment in which an indefinite number of people use the biometric apparatus. Moreover, when the authentication is implemented without a jig, such as a finger placement guide for fixing the position and angle of the finger or palm, being provided, similar concerns arise.

Therefore, it is an object of the present invention to provide a biometric apparatus capable of reducing failures in authentication without providing a jig for fixing the position and angle of the finger or palm, such as a finger placement guide.

The following is a brief description of the gist of the representative elements of the invention laid open in this application.

The biometric apparatus according to the present invention comprises: a biometric information obtaining unit for obtaining the biometric information of a user; a storage unit in which the biometric information of the user is previously registered; an authentication processing unit for comparing the biometric information obtained by the biometric information obtaining unit with the biometric information registered in the storage unit to perform authentication processing of the user; and a display unit for displaying the processing information of the authentication processing unit, wherein the authentication processing unit obtains first contour information during a trial authentication of the user based on the biometric information of the user registered in the storage unit to display the obtained first contour information on the display unit.

The biometric apparatus according to the present invention also comprises: a biometric information obtaining unit for obtaining the biometric information of a user; a storage unit in which authentication information and biometric information of the user are previously registered; a authentication processing unit for comparing input information of the authentication information from the user with the authentication information registered in the storage unit to perform authentication of the user, and for subsequently performing biometric authentication of the user by comparing the biometric information obtained by the biometric information obtaining unit with the biometric information registered in the storage unit; and a display unit for displaying the processing information of the authentication processing unit, wherein the authentication processing unit obtains first contour information during a trial authentication of the user based on the biometric information of the user registered in the storage unit to display the first contour information on the display unit.

The following is a brief description of the effects obtained by the representative elements of the invention laid open in this application.

According to the present invention, during the trial authentication, the user is capable of adjusting the position and angle while watching a screen. Therefore, the user is capable of reducing failures in authentication.

Furthermore, according to the present invention, since only the contour information of the organism is displayed and important data used for the authentication, such as a vein pattern, is not displayed, security level is not decreased.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the configuration of a biometric apparatus according to an embodiment 1 of the present invention;

FIGS. 2A and 2B are block diagrams showing the configuration of a finger vein authentication module of the biometric apparatus according to the embodiment 1 of the present invention;

FIG. 3 is a flowchart showing the operation of the biometric apparatus according to the embodiment 1 of the present invention;

FIG. 4 is a block diagram showing the configuration of a biometric apparatus according to an embodiment 2 of the present invention;

FIG. 5 is an explanatory diagram showing an application example of the biometric apparatus according to the embodiment 2 of the present invention;

FIG. 6 is a flowchart showing the operation of the biometric apparatus according to the embodiment 2 of the present invention;

FIG. 7 is an explanatory diagram explaining the determination on whether a failure in matching during the operation of the biometric apparatus according to the embodiment 2 of the present invention is caused by the displacement of an organism; and

FIG. 8 is a functional block diagram showing the configuration of a biometric apparatus according to an embodiment 3 of the present invention.

### DESCRIPTION OF THE EMBODIMENTS

Embodiments of the present invention will be described in detail in the following sections with reference to appended drawings. It should be noted that like symbols are, in principle, used for like members throughout the entire drawings for explaining the embodiments, and repeated explanation is omitted.

### Embodiment 1

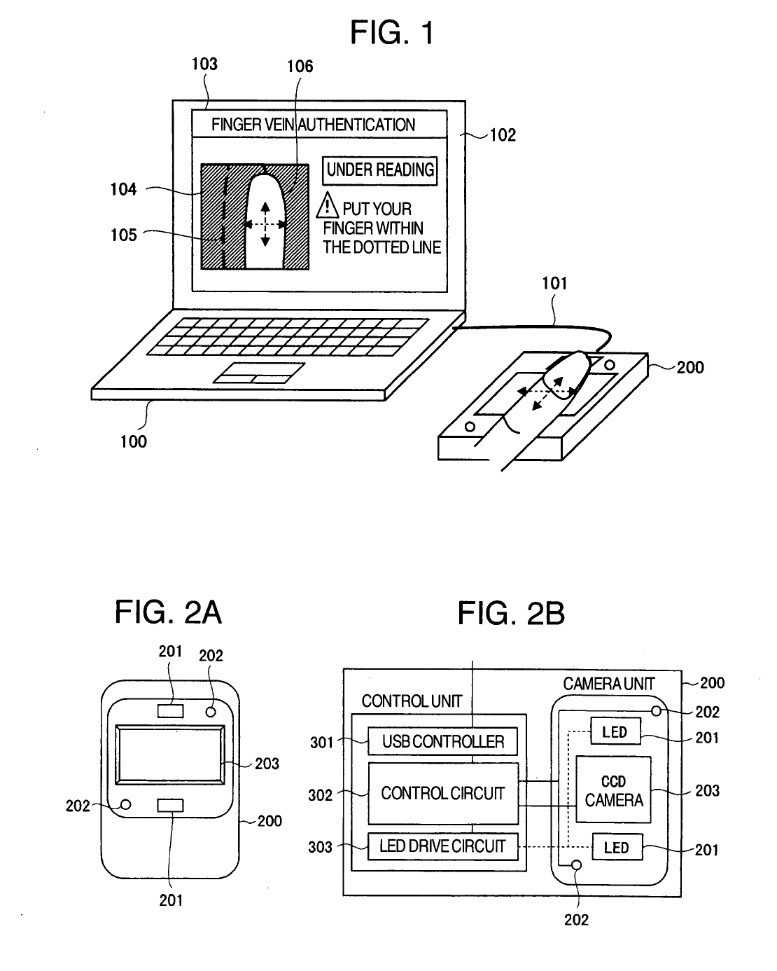

The configuration of the biometric apparatus according to an embodiment 1 of the present invention will be described with reference to FIG. 1, and FIGS. 2A and 2B. FIG. 1 is a block diagram showing the configuration of the biometric apparatus according to the embodiment 1 of the present invention, while FIGS. 2A and 2B are block diagrams showing the configuration of a finger vein authentication module of the biometric apparatus according to the embodiment 1 of the present invention. FIG. 2A shows the external appearance of the finger vein authentication module and FIG. 2B shows the internal configuration of the finger vein authentication module.

In FIG. 1, the biometric apparatus comprises a personal computer (referred to as PC hereinafter) 100 and a finger vein authentication module 200, as a finger vein authentication information obtaining unit, wherein the PC 100 is connected to the finger vein authentication module 200 via a USB cable 101.

The PC 100 comprises: a database, as a storage unit for storing a user authentication code, and a finger vein template for authenticating a user's finger vein; an authentication processing unit for performing authentication processing based on the information from the finger vein authentication module 200 by implementing a finger vein authentication application or the like; and a liquid crystal display 102, as a display unit. In a finger vein authentication application display area 103 of the liquid crystal display 102, a picked-up image display area 104 is displayed. In the display area 103, finger contour position information 105 during the registration of the finger vein template, and finger contour information 106 at the current finger position are also displayed.

In FIGS. 2A and 2B, the finger vein authentication module comprises a camera unit and a control unit. The camera unit comprises a CCD camera 203, a near infrared ray LED 201, and an access lamp 202. The control unit comprises a LED drive circuit 303, a control circuit 302, and a USB controller 301.

When a user places his or her finger on the finger vein authentication module 200, the near infrared ray irradiated from the near infrared ray LED 201 passes through internal of the finger and the CCD camera 203 disposed below an imaging window takes an image of the transmitted light. At this time, the vein appears black due to its character to absorb the near infrared ray, thus making it possible to obtain a vein pattern. The vein pattern, which differs from individual to individual, can be utilized as biometric information.

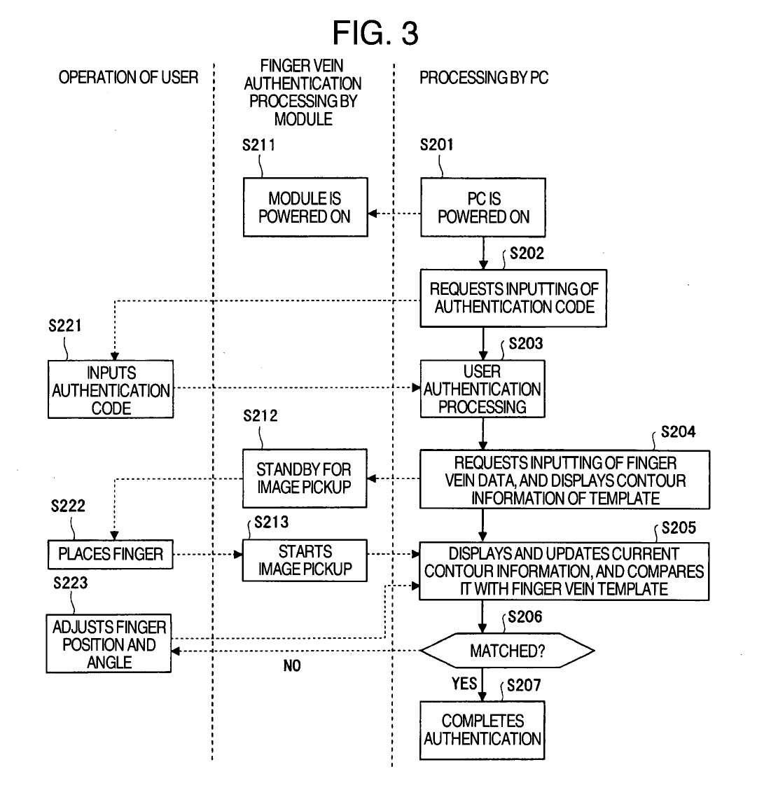

Next, the operation of the biometric apparatus according to the embodiment 1 of the present invention will be described with reference to FIG. 3. FIG. 3 is a flowchart showing the operation of the biometric apparatus according to the embodiment 1 of the present invention.

First, when the PC 100 is powered on (S201), the finger vein authentication module is also powered on (S211).

Next, the PC100 requests a user (referred to user A hereinafter), who attempts the use of the PC100, to input an authentication code (S202). The user inputs his or her authentication code in response to the request (S221).

The PC100 makes an inquiry to the database in which a previously registered user authentication code is stored, and if the user authentication code matches the inputted authentication code, then the PC100 determines the user A as an authorized user, and completes the first authentication processing (S203).

Next, the PC100 requests the user A to input finger vein data. The PC100 also simultaneously displays the finger contour position information 105, which shows the finger contour position during the registration of finger vein template, on the picked-up image display area 104 (S204).

After S204, the finger vein authentication module 200 comes in a state of standby for picking up images, and when the user A places his or her finger on the finger vein authentication module 200 (S222), the finger vein authentication module starts the image pick-up (S213).

The image pick-up is performed in a continuous and repeated manner like 5 times every second until the completion of the authentication (S207).

Every time the PC100 obtains picked-up image data through the finger vein authentication module 200, the PC100 obtains current finger contour position information from the picked-up image to update the finger contour information 106 displayed in the picked-up image display area 104.

Simultaneously, the PC100 compares the finger vein data of the user A just obtained with the data of the finger vein template of the user A previously registered in the PC100 (S205).

The PC100 determines whether both data matches to the extent beyond a certain predetermined criterion (S206), and if both data matches at S206, then the authentication of the user A completes (S207), and the user A is allowed to start the use of the PC100.

If both data do not match with each other and thereby the authentication does not complete, the user determines that the position of the user's finger is not correct, and moves the finger so that the current finger contour position information gets close to the finger contour position information 105 captured during the registration of the finger vein template while checking the finger contour position information 105 in the picked-up image display area 104, or operates to change the angle of the finger by rotating it about the axis in the longitudinal direction of the finger (S223).

As described in the foregoing, in the present embodiment, when authenticating the user's finger vein, the finger contour position information 105 during the registration of the finger vein template for performing the finger vein authentication is displayed, and then current finger contour position information is obtained based on the finger vein authentication module 200 and displayed. Therefore, the user is capable of adjusting the position and angle of the organism while watching the screen, and thereby capable of reducing failures in authentication.

Moreover, in the present embodiment, only the finger contour position information 105 during the registration of the finger vein template and the finger contour information 106 at the current position of the finger are displayed, and important data, such as the vein pattern, that is used for the authentication is not displayed. Therefore, it is possible to execute the authentication without decreasing the security level.

### Embodiment 2

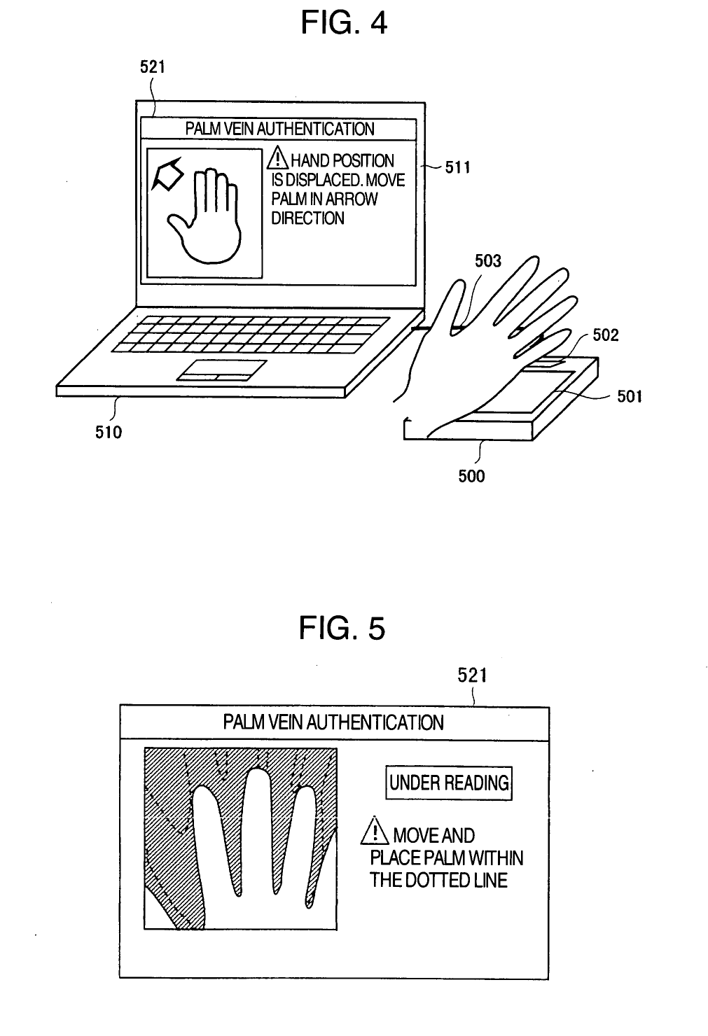

The configuration of a biometric apparatus according to an embodiment 2 of the present invention will be described with reference to FIGS. 4 and 5. FIG. 4 is a block diagram showing the configuration of the biometric apparatus according to the embodiment 2 of the present invention. FIG. 5 is an explanatory drawing explaining an exemplary application of the biometric apparatus according to the embodiment 2 of the present invention.

In FIG. 4, the biometric apparatus comprises a PC510 and a palm vein authentication module 500 connected to the PC510.

The palm vein authentication module 500 comprises a CCD camera 501 and a near infrared LED 502, and is connected to the PC510, which is equipped with a liquid crystal display 511, via a USB cable 503 through a USB interface.

A correct direction of the organism's position is displayed in a display area 521 of a palm authentication application which is activated on the PC510.

In the palm vein authentication, when the imaging range of the CCD camera 501 is large enough to cover part of the palm contour, a correct position of the organism and a correct direction of the position of the organism can be displayed to the user in the same manner as the embodiment 1 as FIG. 5 shows by displaying part of the contour on the screen. Therefore, in the present embodiment, a case is discussed in which the palm contour does not lie within the imaging range.

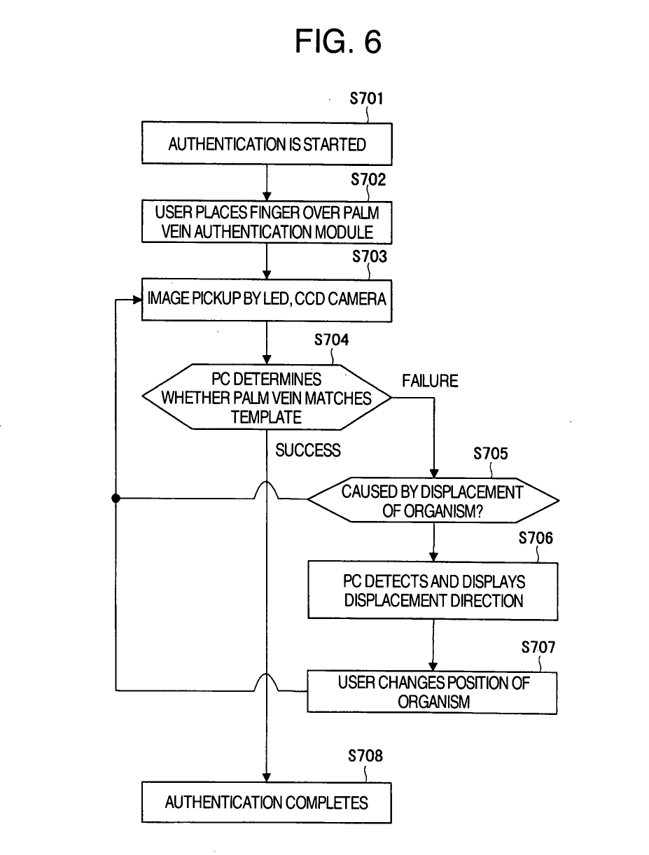

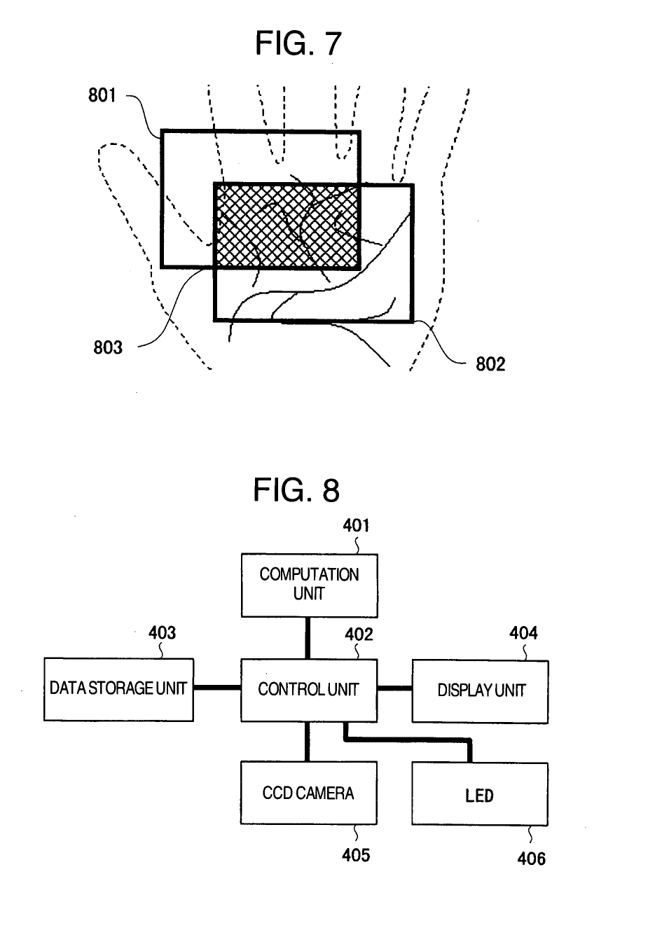

Next, the operation of the biometric apparatus according to the embodiment 2 of the present invention will be described with reference to FIGS. 6 and 7. FIG. 6 is a flowchart showing the operation of the biometric apparatus according to the embodiment 2 of the present invention. FIG. 7s is an explanatory drawing explaining whether a failure in matching during the operation of the biometric apparatus according to the embodiment 2 of the present invention is caused by the displacement of the organism.

First, a user starts the authentication in an attempt to use the authentication (S701).

Then, when the user A places his or her finger over the palm vein authentication module 500 (S702), the PC510 uses a CPU and a chip set to control the near infrared ray LED 502 and CCD camera 501 and perform image pickup (S703).

Then, the PC510 makes an inquiry to the database in the hard disc, in which the previously registered palm vein template is stored, about the obtained palm vein pattern to determine whether the obtained palm vein matches any of the template data within the database (S704).

When the matching turns out to be successful at S704, the authentication completes (S708). However, when the matching turns out to be a failure at S704, the PC510 determines whether it is caused by the displacement of the organism (S705).

An exemplary determination method is shown in FIG. 7. As is shown in FIG. 7, a vein pattern in a current picked-up image display area 801 is compared with a vein pattern in a picked-up image of template display area of 802. If, although the total matching ratio falls below an acceptance criterion, an exact match is found in a partial pattern 803, it is possible to determine that the position of the organism is displaced, and to discriminate the displacement direction from a match position.

When the PC510 detects that the organism is displaced in position and direction, the PC510 informs the user A that the organism is displaced, displays the correct direction or displaced direction on the screen, and instructs the user A to move his or her palm to the correct position (S706).

The user A moves the palm following the instructions on the screen (S707).

The PC510 and user A continuously perform S703 through S707 until the comparison results in a match, and the PC510 periodically updates the display on the liquid crystal display.

When the current position of the palm gets close to the template sufficiently enough to ensure a successful match, as far as a person who attempts the authentication is the authorized person, the obtained palm vein pattern matches the palm vein pattern of the template sufficiently, resulting in the completion of the authentication (S708).

As described in the foregoing, in the present embodiment, in authenticating a user's palm vein, if a successful match is not obtained, determination is made on whether it is caused by the displacement of the organism. If it is determined to be caused by the displacement of the organism, then the user can adjust the position of the organism during the trial authentication while watching the screen, thus enabling the reduction of failures in authentication.

### Embodiment 3

The configuration of a biometric apparatus according an embodiment 3 of the present invention will be described with reference to FIG. 8. FIG. 8 is a functional block diagram showing the configuration of the biometric apparatus according to the embodiment 3 of the present invention.

In FIG. 8, the biometric apparatus comprises: a computation unit 401; a control unit 402; a data storage unit 403; a display unit 404; a CCD camera 405; and a near infrared ray LED 406.

The computation unit 401 performs computation so that the control unit 402 controls each unit.

The control unit 402 controls each operation of the computation unit 401, data storage unit 403, display unit 404, CCD camera 405, and near infrared ray Led 406.

The data storage unit 403 stores software for causing the biometric apparatus to operate, and also stores biometric patterns for authenticating individuals.

The display unit 404 provides the user with various screen displays.

In the present embodiments, correct position of the organism or correct direction of position of the organism is displayed on the display unit 404.

The CCD camera 405 is operation-controlled by the control unit 402 and photographs a biometric pattern surfaced by the near infrared ray irradiated by the near infrared ray LED 406.

The near infrared LED 406 is operation-controlled by the control unit and irradiates near infrared rays.

The authentication operation by the control unit 402 and computation unit 401 of the present embodiment is the same as that described in the embodiments 1 and 2.

Description has been provided to the invention invented by inventors in a specific manner based on the embodiments thereof in the foregoing. However, it goes without saying that the present invention is not limited to the foregoing embodiments, and various changes can be made without departing from the scope of the invention.

For example, while in the embodiments 1 and 2, description has been made by way of an example in which the biometric apparatus comprises the PC100, PC510; and the finger vein authentication module 200 and palm vein authentication module 500, and in the embodiment 3, the apparatus represented by the functional blocks has been described, there is no limitation thereto. Any apparatus and system may be used that comprises a vein authentication information obtaining unit for obtaining finger vein authentication information and palm vein authentication information; a storage unit; an authentication processing unit for performing vein authentication processing; and a display unit for displaying various information.

Furthermore, while in the embodiments 1 and 2, description has been made by way of examples of authentication in which the finger vein authentication and palm vein authentication are used, there is no limitation to the finger vein authentication and palm vein authentication, and authentication may be performed that uses other biometric information.

It should be further understood by those skilled in the art that although the foregoing description has been made on embodiments of the invention, the invention is not limited thereto and various changes and modifications may be made without departing from the spirit of the invention and the scope of the appended claims.

1. A biometric apparatus for performing user authentication in noncontact manner based on biometric information, said apparatus comprising:
a biometric information obtaining unit for obtaining biometric information of a user;
a storage unit in which biometric information of said user is previously stored;
an authentication processing unit for comparing the biometric information obtained by said biometric information obtaining unit with the biometric information registered in said storage unit to perform authentication processing of said user; and
a display unit for displaying information for providing instructions to change the position where an object to be authenticated is placed in response to the authentication result of said authentication processing unit.

2. The authentication apparatus according to claim 1, further comprising:
input means for inputting a user authentication code which is established for each registration biometric information of the user registered in said storage unit; and
means for determining whether the inputted user authentication code is registered or not,
wherein said authentication processing unit refers to the biometric information, which is recorded in said storage unit and corresponds to said inputted user authentication code, to perform the authentication processing when said inputted user authentication code is determined to have been registered.

3. The authentication apparatus according to claim 1, wherein:
said biometric information obtaining unit takes an image a finger vein pattern to provide biometric information of the user.

4. The authentication apparatus according to claim 1, wherein:
said biometric information obtaining unit takes an image of a palm vein pattern to provide biometric information of the user.

5. The authentication apparatus according to claim 1, wherein:
said authentication processing unit compares the biometric information of the user obtained by said biometric information obtaining unit with the pattern of the biometric information registered in said storage unit to detect a displaced direction of the pattern and display information for providing instructions to change the direction on said display unit.

6. The authentication apparatus according to claim 1, wherein:
said authentication processing unit determines the displacement direction from a match part when the biometric information of the user obtained by said biometric information obtaining unit partially matches the pattern of the biometric information registered in said storage unit.

7. A biometric apparatus for performing authentication of a user in a noncontact manner based on the biometric information, said apparatus comprising:
a biometric information obtaining unit for obtaining biometric information of a user;
a storage unit in which said user's biometric information of the user is previously stored;
an authentication processing unit for comparing the biometric information obtained by said biometric information obtaining unit with the biometric information registered in said storage unit to perform authentication processing of said user; and
a display unit for relating the contour shape information of the biometric information obtained by said biometric information obtaining unit and the contour shape information of the biometric information during the registration which is recorded in said storage unit to each obtained position for displaying.

8. The biometric apparatus according to claim 7, further comprising:
input means for inputting a user authentication code which is established for each registration biometric information of the user registered in said storage unit; and
means for determining whether the inputted user authentication code is registered or not,
wherein said authentication processing unit refers to the biometric information corresponding to the user authentication code, which is stored in said storage unit and inputted, when said inputted user authentication code is determined to have been registered.

9. The biometric apparatus according to claim 7, wherein:
said biometric information obtaining unit takes an image of a finger vein pattern to provide biometric information of the user.

10. The biometric apparatus according to claim 7, wherein:
said biometric information obtaining unit takes an image of a palm vein pattern to provide biometric information of the user.

11. An authentication method of the authentication apparatus for performing user authentication in a noncontact manner based on biometric information, the method comprising the steps of:
obtaining biometric information of a user;
displaying obtained position information of obtained biometric information of the user and registered position information of previously registered biometric information;
comparing the obtained biometric information with previously registered biometric information; and
completing the authentication when there is a match in said biometric information beyond a predetermined extent, and repeating said steps if that is not the case.

12. The authentication method according to claim 11, comprising, before the step of obtaining, the steps of:
inputting the user authenticating code which is established for each registration biometric information of the user; and
determining whether said inputted user authentication code is the authentication code corresponding to the registered biometric information to suspend the authentication processing when it is not the registered authentication, the steps being included before the steps described in claim 11.

13. The authentication method according to claim 11, wherein:
said obtained position information of the biometric information and said registered position information of the biometric information are contour shape information of finger or palm.

14. The authentication method according to claim 11, comprising the steps:
comparing obtained biometric information of the user with the pattern of registered biometric information to detect a displaced direction; and
displaying instructions to instruct the user to change the position at which an object to be authenticated is placed.

15. The authentication method according to claim 14, comprising the steps of:
determining the displacement direction from a match part when the biometric information of the user obtained from said biometric information obtaining unit partially matches the pattern of biometric information registered in said storage unit.
